(19) United States
(12) Patent Application Publication
(10) Pub. No.: US 2008/0052382 A1
(43) Pub. Date: Feb. 28, 2008

(54) METHOD AND APPARATUS FOR CLOSING BROWSER WINDOWS AFTER A MAXIMUM IDLE TIME

(76) Inventors: Hung The Dinh, Austin, TX (US); Teng S. Hu, Austin, TX (US); Dinh Tran Le, San Antonio, TX (US); Phong Anh Pham, Austin, TX (US)

Correspondence Address: IBM CORP (YA);C/O YEE & ASSOCIATES PC, P.O. BOX 802333, DALLAS, TX, 75380, US

(21) Appl. No.: 11/466,534

(22) Filed: Aug. 23, 2006

(51) Int. Cl. G06F 15/173

(52) U.S. Cl. 709/223; 709/225

(57) ABSTRACT

A computer implemented method, apparatus, and computer usable program product for managing browser windows. A determination is made as to whether window management is enabled for a window associated with a browser by checking a set of stored parameters, wherein the window displays content from a source identified by a uniform resource locator. A further determination is made as to whether a selected uniform resource locator designated for window management in the set of stored parameters matches the uniform resource locator in response to the window being enabled for window management. The window is closed if a selected period of time associated with the selected uniform resource locator has elapsed without user activity in response to the uniform resource locator matching the selected uniform resource locator.

### BACKGROUND OF THE INVENTION

1. Field of the Invention

The present invention relates generally to an improved data processing system and in particular to a method and apparatus for managing a browser. Still more particularly, the present invention relates to a computer implemented method, apparatus, and computer usable program product for closing windows in a browser.

2. Description of the Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses have created Internet sites as an integral part of their marketing efforts, informing consumers of the products or services offered by the business or providing other information seeking to engender brand loyalty. Many federal, state, and local government agencies are also employing Internet sites for informational purposes. Further, the Internet is becoming increasingly popular as a medium for commercial transactions.

Currently, the most commonly employed method of transferring data over the Internet is to employ the World Wide Web environment, also called simply “the Web”. In the Web environment, servers and clients effect data transaction using the Hypertext Transfer Protocol (HTTP), a known protocol for handling the transfer of various data files. Examples of these types of data files include text, still graphic images, audio, and motion video. The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A uniform resource locator is a special syntax identifier, defining a communications path to specific information. The uniform resource locator provides a universal, consistent method for finding and accessing this information, not necessarily for the user, but mostly for the user's Web “browser”. A browser is a program capable of submitting a request for information identified by an identifier, such as, for example, a uniform resource locator. A user may enter a domain name through a graphical user interface (GUI) for the browser to access a source of content.

Currently, transactions performed via the Web typically use a browser application. Oftentimes, personal confidential information is retrieved and displayed. Currently, a user must close the window containing the personal information or lock the computer to prevent others from viewing any sort of personal or confidential information.

### SUMMARY OF THE INVENTION

The present invention provides a computer implemented method, apparatus, and computer usable program product for managing browser windows. A determination is made as to whether window management is enabled for a window associated with a browser by checking a set of stored parameters, wherein the window displays content from a source identified by a uniform resource locator. A further determination is made as to whether a selected uniform resource locator designated for window management in the set of stored parameters matches the uniform resource locator in response to the window being enabled for window management. The window is closed if a selected period of time associated with the selected uniform resource locator has elapsed without user activity in response to the uniform resource locator matching the selected uniform resource locator.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 depicts a block diagram of a data processing system in which illustrative embodiments may be implemented;

FIG. 3 is a block diagram of a browser program in accordance with an illustrative embodiment;

FIG. 4 is a diagram illustrating a window for managing browser windows in accordance with an illustrative embodiment; and

FIG. 5 is a flowchart of a process for managing windows in accordance with an illustrative embodiment.

### DETAILED DESCRIPTION OF THE PREFERRED EMBODIMENT

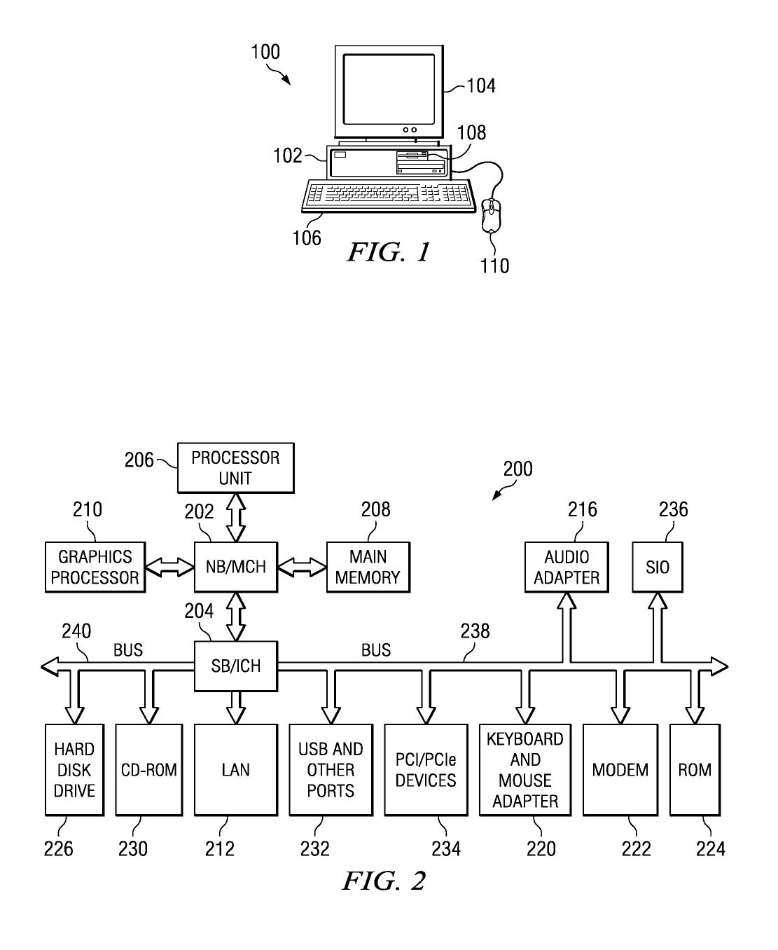

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices include a joystick, touchpad, touch screen, trackball, microphone, and the like.

Computer 100 may be any suitable computer, such as an IBM® eServer™ computer or IntelliStation® computers, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206. This operating system coordinates and controls various components within data processing system 200 in FIG. 2. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processor 206. The processes of the illustrative embodiments may be performed by processor 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionaly, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

The illustrative embodiments provide a computer implemented method, apparatus, and computer usable program product for managing browser windows. A determination is made as to whether a selected uniform resource locator is present for a window associated with a browser. This window displays content for a uniform resource locator. If the uniform resource locator for the window matches the selected uniform resource locator, the window is closed if a selected period of time associated with the uniform resource locator has elapsed. In this manner, personal confidential information that may be displayed in the window may be secured by closing the window after some period of time passes. As a result, other parties are unable to view the information.

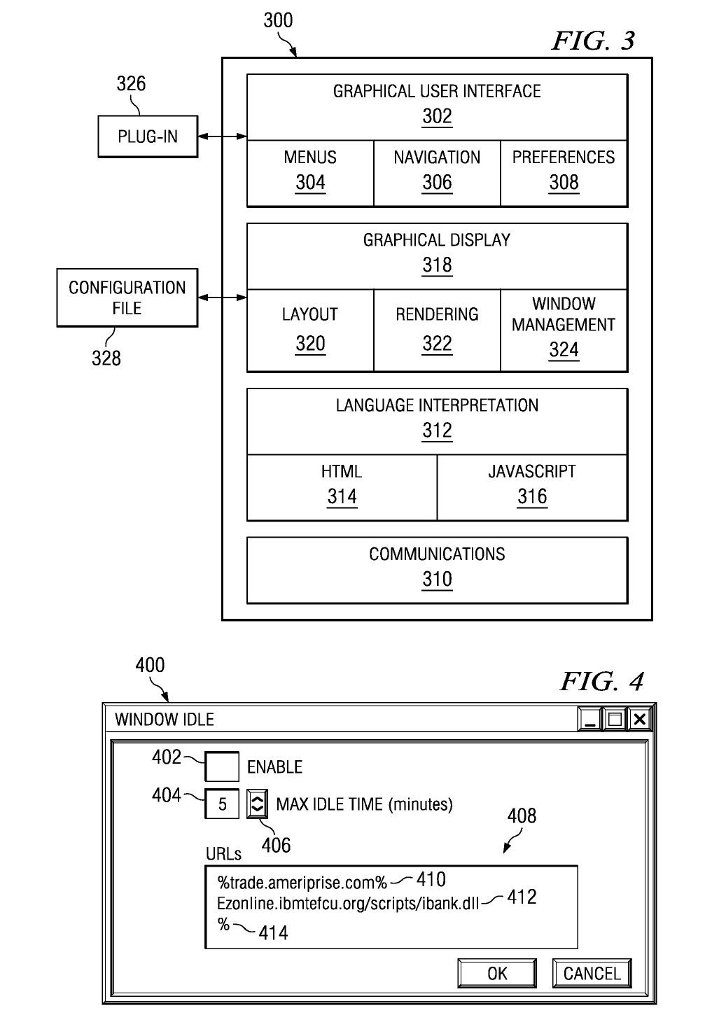

Turning next to FIG. 3, a block diagram of a browser program is depicted in accordance with an illustrative embodiment. A browser is an application used to navigate or view information or data in a distributed database, such as the Internet or the World Wide Web.

In this example, browser 300 includes a user interface 302, which is a graphical user interface (GUI) that allows the user to interface or communicate with browser 300. This interface provides for selection of various functions through menus 304 and allows for navigation through navigation 306. For example, menu 304 may allow a user to perform various functions, such as saving a file, opening a new window, displaying a history, and entering a uniform resource locator. Navigation 306 allows for a user to navigate various pages and to select web sites for viewing. For example, navigation 306 may allow a user to see a previous page or a subsequent page relative to the present page. Preferences such as those illustrated in FIG. 3 may be set through preferences 308.

Communications 310 is the mechanism with which browser 300 receives documents and other resources from a network such as the Internet. Further, communications 310 is used to send or upload documents and resources onto a network. In the depicted example, communication 310 uses HTTP. Other protocols may be used depending on the implementation. Documents that are received by browser 300 are processed by language interpretation 312, which includes an HTML unit 314 and a JavaScript unit 316. Language interpretation 312 will process a document for presentation on graphical display 318. In particular, HTML statements are processed by HTML unit 314 for presentation while JavaScript statements are processed by JavaScript unit 316.

Graphical display 318 includes layout unit 320, rendering unit 322, and window management 324. These units are involved in presenting web pages to a user based on results from language interpretation 312.

Browser 300 is presented as an example of a browser program in which illustrative embodiment may be embodied. Browser 300 is not meant to imply architectural limitations to the present invention. A browser may be any application that is used to search for and display content on a distributed data processing system. Browser 300 may be implemented using known browser applications, such as Microsoft Internet Explorer. Microsoft Internet Explorer is available from Microsoft Corporation.

Browser 300 also includes plug-in 326. The window management features provided to close windows after some selected period of time may be implemented in plug-in 326. Alternatively, these processes may be implemented within browser 300, itself. For example, the processes may be implemented in window management 324. Parameters and configuration information such as whether the features is enabled or disabled, the maximum idle time, and a designation of a set of one or more uniform resource locators may be stored in a data structure, such as configuration file 328. The designation of this information may be made thought graphical user interface 302 in these illustrative examples.

Turning now to FIG. 4, a diagram illustrating a window for managing browser windows in depicted in accordance with an illustrative embodiment. In this example, window 400 is an example of a user interface that may be presented though graphical user interface 302 in FIG. 3.

In this particular example, window 400 contains control 402, which is a checkbox. Control 402 allows a user to enable or disable this window management feature. Further, enablement or disablement of the feature may be handled using other mechanisms. A menu in the browser window or the pressing of a particular function or set of keys may enable or disable this feature.

Max idle time field 404 in window 400 indicates the period of time that elapses before a window is closed. This number may be changed by entering a new number in max idle time field 404 or by manipulating controls 406. Max idle time field 404 is used to enter the maximum idle time in these examples. The designation of a set of uniform resource locators for which window management occurs may be made in field 408. In this particular example, line 410 in field 408 indicates that some uniform resource locators are to be managed in this manner. Any uniform resource locator containing the pattern in line 410 is managed using the window management feature. In line 412, a specific uniform resource locator is entered for management using the process in the illustrative embodiments. Line 414 indicates that all uniform resource locators for windows are to be handled in this manner. As a result, when a specific window is opened and the elapsed time occurs, the browser closes the window.

In these examples, if the window is the last window, the execution of the browser terminates or exits. The information entered in window 400 may be stored in a configuration file, such as configuration file 328 in FIG. 3.

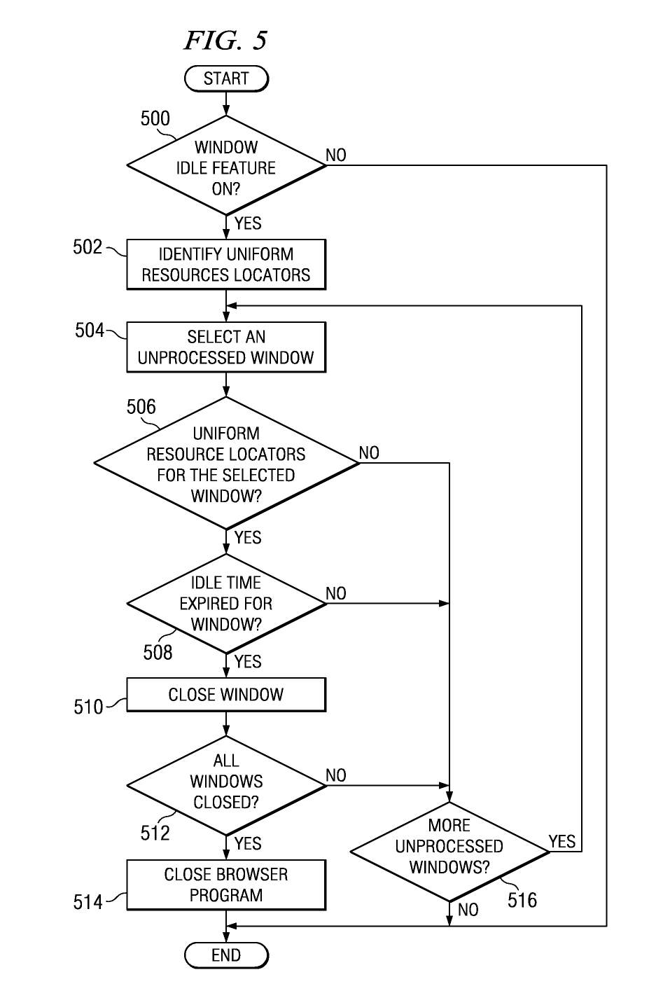

Turning now to FIG. 5, a flowchart of a process for managing windows is depicted in accordance with an illustrative embodiment. In this example, the process illustrated in FIG. 5 may be implemented in a software component, such as plug-in 326 in FIG. 3 or browser 300 in FIG. 3.

The process begins by determining whether the window idle feature is on (step 500). If the window idle feature is not on, the process terminates. Otherwise, uniform resource locators are identified for processing (step 502). These uniform resource locators are ones that are entered by a user. Specific uniform resource locators may be entered. Alternatively, a pattern entered by a user may be matched for uniform resource locators, or all uniform resource locators may be processed.

Next, a window is selected for processing (step 504). A determination is then made as to whether a uniform resource locator in the identified uniform resource locators is in the uniform resource locator for selected window (step 506). A uniform resource locator is for the window if the content presented in the window is for the uniform resource locator. If the uniform resource locator is present in that window, a determination is made as to whether idle time has expired for this window (step 508). Idle time is the amount of time that has passed since activity has occurred in that window being processed. Depending on the particular implementation, this idle time could be for the last activity that has occurred in any window for the browser or for any activity on the desktop on the computer itself. If the idle time has expired, the window is closed (step 510).

Thereafter, a determination is made as to whether all of the windows have been closed (step 512). If all of the windows have been closed, the browser program is closed (step 514) with the process terminating thereafter. Step 514 is an example of an optional step that may be omitted depending on the implementation.

With reference again to step 512, if not all of the windows have been closed, a determination is made as to whether additional unprocessed windows are present (step 516). If additional unprocessed windows are present, the process returns to step 504 to select another unprocessed window. Turning back to step 508, the process also proceeds to step 516 if the idle time has not expired. The process returns to step 516 from step 506 in the same manner if the uniform resource locator is not for the window being processed.

Thus, the present invention provides a computer implemented method, apparatus, and computer usable program product for managing browser windows. A determination is made as to whether a selected uniform resource locator is present for a window associated with a browser. This window displays content for a uniform resource locator. This determination is made in response to the window being enabled for window management. If the uniform resource locator, for the window matches the selected uniform resource locator the window is closed if a selected period of time associated with the uniform resource locator has elapsed. In this manner, the different illustrative embodiments allow for increased security for confidential information that is displayed in a browser window.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing browser windows, the computer implemented method comprising:
determining whether window management is enabled for a window associated with a browser by checking a set of stored parameters, wherein the window displays content from a source identified by a uniform resource locator;
responsive to the window being enabled for window management, determining whether a selected uniform resource locator designated for the window management in the set of stored parameters matches the uniform resource locator; and
responsive to the uniform resource locator matching the selected uniform resource locator, closing the window if a selected period of time associated with the selected uniform resource locator has elapsed without user activity.

2. The computer implemented method of claim 1 further comprising:
responsive to closing the window, determining whether any windows are open for the browser; and
ending execution of the browser if an open window for the browser is absent.

3. The computer implemented method of claim 1 further comprising:
displaying a user interface for the browser, wherein the user interface allows a user to designate the selected uniform resource locator for window management and set the period of time.

4. The computer implemented method of claim 1, wherein the user activity is user activity in the window.

5. The computer implemented method of claim 1, wherein the method is implemented in one of a plug-in or the browser.

6. A computer program product comprising:
a computer usable medium having computer usable program code for managing browser windows, the computer program medium comprising:
computer usable program code for determining whether window management is enabled for a window associated with a browser by checking a set of stored parameters, wherein the window displays content from a source identified by a uniform resource locator;
computer usable program code, responsive to the window being enabled for window management, for determining whether a selected uniform resource locator designated for window management in the set of stored parameters matches the uniform resource locator; and
computer usable program code, responsive to the uniform resource locator matching the selected uniform resource locator, for closing the window if a selected period of time associated with the selected uniform resource locator has elapsed without user activity.

7. The computer program product of claim 6 further comprising:
computer usable program code, responsive to closing the window, determining whether any windows are open for the browser; and
computer usable program code for ending execution of the browser if an open window for the browser is absent.

8. The computer program product of claim 6 further comprising:
computer usable program code for displaying a user interface for the browser, wherein the user interface allows a user to designate the selected uniform resource locator for window management and set the period of time.

9. A data processing system comprising:
a bus;
a communications unit connected to the bus;
a storage device connected to the bus, wherein the storage device includes computer usable program code; and
a processor unit connected to the bus, wherein the processor unit executes the computer usable program code to determine whether window management is enabled for a window associated with a browser by checking a set of stored parameters, wherein the window displays content from a source identified by a uniform resource locator; determine whether a selected uniform resource locator designated for the window management in the set of stored parameters matches the uniform resource locator in response to the window being enabled for window management; and close the window if a selected period of time associated with the selected uniform resource locator has elapsed without user activity in response to the uniform resource locator matching the selected uniform resource locator.

10. The data processing system of claim 9, wherein the processor unit further executes the computer usable program code to determine whether any windows are open for the browser in response to closing the window; and end execution of the browser if an open window for the browser is absent.

11. The data processing system of claim 9, wherein the processor unit further executes the computer usable program code to display a user interface for the browser, wherein the user interface allows a user to designate the selected uniform resource locator for window management and set the period of time.

12. The data processing system of claim 9, wherein the user activity is user activity in the window.

13. The data processing system of claim 9, wherein the method is implemented in one of a plug-in or the browser.
